(19) United States
(12) Patent Application Publication
(10) Pub. No.: US 2026/0288053 A1
(43) Pub. Date: Sep. 24, 2026

(54) HOUSING AND IMAGE FORMING APPARATUS

(71) Applicant: FUJIFILM Business Innovation Corp., Tokyo (JP)

(72) Inventor: Toshihiro GODA, Kanagawa (JP)

(73) Assignee: FUJIFILM Business Innovation Corp., Tokyo (JP)

(21) Appl. No.: 19/315,227

(22) Filed: Aug. 29, 2025

(30) Foreign Application Priority Data
Mar. 19, 2025 (JP) 2025-046013

(51) Int. Cl. G03G 21/16; G03G 15/00

(52) U.S. Cl. CPC G03G 21/1633; G03G 15/80; G03G 21/1619; G03G 2221/1687; G03G 2221/169

(57) ABSTRACT

A housing includes a storage unit that is made of metal and that stores plural boards arranged at intervals in a thickness direction of the boards; and an opening-closing member that is made of metal, that is attached to a wall defining the storage unit at a far side in an insertion direction of the boards, that covers and uncovers an opening in the wall from outside of the storage unit, and to which one of the boards that is closest to the far side in the insertion direction is attached.

### CROSS-REFERENCE TO RELATED APPLICATIONS

This application is based on and claims priority under 35 USC 119 from Japanese Patent Application No. 2025-046013 filed March 19, 2025.

### BACKGROUND

### (i) Technical Field

The present disclosure relates to a housing and an image forming apparatus.

### (ii) Related Art

Japanese Unexamined Patent Application Publication No. 2009-11507 describes a housing mechanism. The housing mechanism includes a housing to which plural circuit boards are fixed in a removable and attachable manner such that the circuit boards are stacked parallel to each other. The housing mechanism includes at least one circuit board that is fixed such that the circuit board is removable and attachable along a direction different from the direction in which the circuit boards are stacked.

Japanese Unexamined Patent Application Publication No. 2015-140936 describes an outdoor unit. The outdoor unit includes a casing, a terminal block attaching plate, and a control board. The casing houses a compressor and a heat exchanger. The terminal block attaching plate is provided in the vicinity of a side face of the casing. The terminal block attaching plate includes a terminal block to which a power source line from an indoor unit is connectable. The control board is provided in the casing. The control board faces the terminal block attaching plate, and is slanted so that the distance between the control board and the terminal block attaching plate decreases toward a back face. In the outdoor unit, the terminal block attaching plate is rotatable away from the control board.

### SUMMARY

Aspects of non-limiting embodiments of the present disclosure relate to a structure in which one of plural boards that is closest to a far side of a storage unit in an insertion direction of the boards is easier to access than when the board closest to the far side of the storage unit is attached to a wall defining the storage unit at the far side.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a housing including a storage unit that is made of metal and that stores plural boards arranged at intervals in a thickness direction of the boards; and an opening-closing member that is made of metal, that is attached to a wall defining the storage unit at a far side in an insertion direction of the boards, that covers and uncovers an opening in the wall from outside of the storage unit, and to which one of the boards that is closest to the far side in the insertion direction is attached.

### BRIEF DESCRIPTION OF THE DRAWINGS

Exemplary embodiments of the present disclosure will be described in detail based on the following figures, wherein:

FIG. 1 is an upper perspective view of an image forming apparatus including a housing according to an exemplary embodiment of the present disclosure;

FIG. 2 is a vertical sectional view of a storage unit of the housing illustrated in FIG. 1 taken along line II-II;

FIG. 3 is a vertical sectional view of the storage unit illustrated in FIG. 2 with an opening-closing member of the storage unit in an open state;

FIG. 4 is a vertical sectional view of a storage unit of a housing according to a modification;

FIG. 5 is a vertical sectional view of a storage unit of a housing according to another exemplary embodiment; and

FIG. 6 is a vertical sectional view of the storage unit illustrated in FIG. 5 with an opening-closing member of the storage unit in an open state.

### DETAILED DESCRIPTION

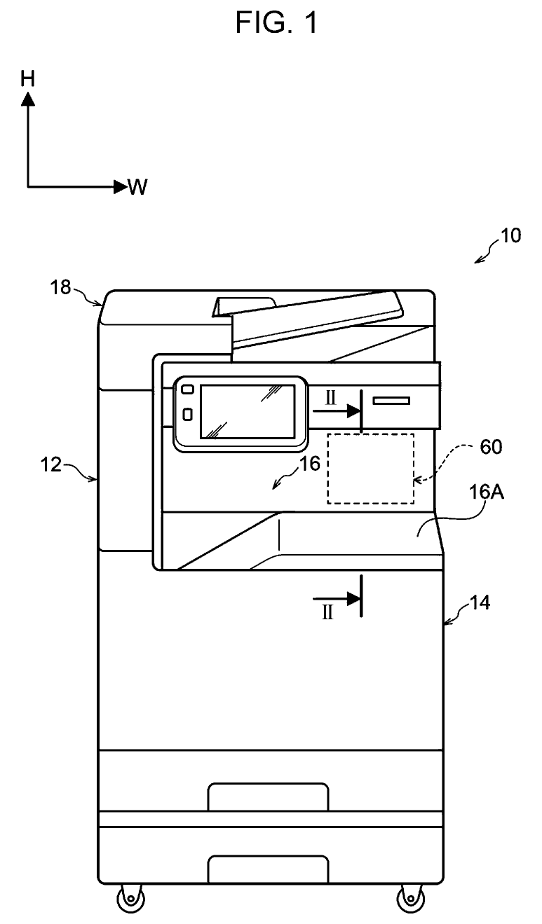

A housing and an image forming apparatus according to an exemplary embodiment of the present disclosure will now be described with reference to FIGS. 1 to 6. In the drawings, the same or equivalent components and parts are denoted by the same reference signs. The dimensional ratios in the drawings are exaggerated for convenience of description, and may differ from the actual ratios.

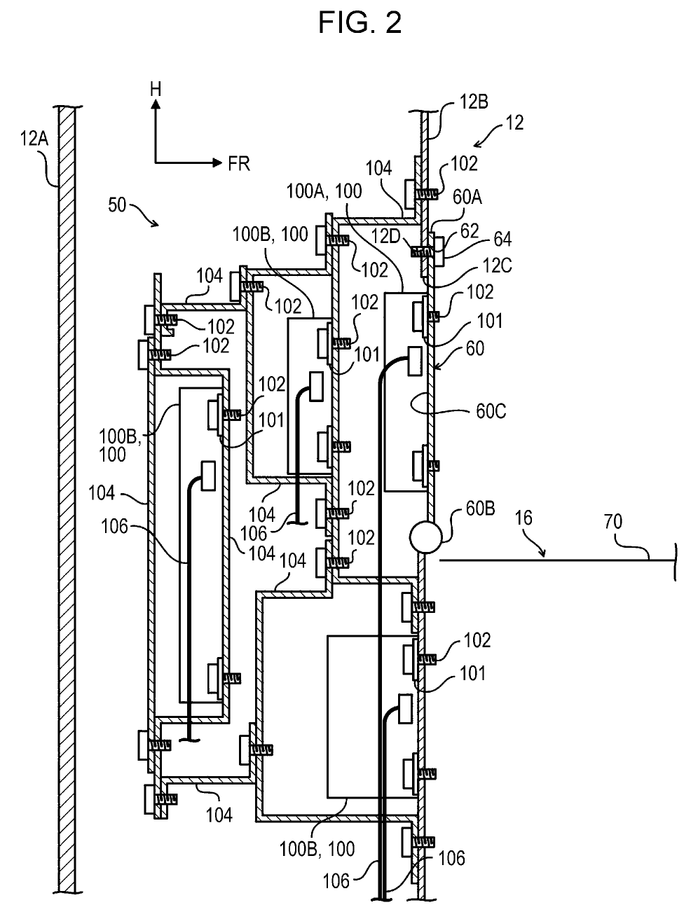

FIG. 1 illustrates an image forming apparatus 10 according to the exemplary embodiment of the present disclosure. As illustrated in FIG. 1, the image forming apparatus 10 according to the exemplary embodiment of the present disclosure includes a housing 12, an image forming unit 14, and a document reader 18. In the following description, the side at which a user who uses the image forming apparatus 10 faces the image forming apparatus 10 (near side of FIG. 1) will be referred to as "front" of the image forming apparatus 10, and the opposite side (far side of FIG. 1) will be referred to as "rear" of the image forming apparatus 10. The front of the image forming apparatus 10 is indicated by arrow FR in FIG. 2. In addition, as illustrated in FIG. 1, the up-down direction of the image forming apparatus 10 is indicated by arrow H. In addition, the width direction of the image forming apparatus 10 is indicated by arrow W. The width direction of the image forming apparatus 10 may also be referred to as the left-right direction as seen from the user who uses the image forming apparatus 10 and faces the image forming apparatus 10.

The image forming unit 14 is provided in the housing 12. The document reader 18 is provided above the housing 12. The housing 12 includes, for example, metal and resin components.

The image forming unit 14 has a function of a laser printer that prints an image on a recording paper sheet by a laser system. As illustrated in FIG. 1, the image forming unit 14 is disposed in a lower section of the image forming apparatus 10. The image forming unit 14 includes a toner-image-forming unit (not illustrated), a transfer unit that transfers a toner image formed by the toner-image-forming unit to a recording paper sheet, and a fixing device that fixes the transferred toner image to the recording paper sheet. The components of the image forming unit 14 are provided in the housing 12, and are controlled by a controller (not illustrated) based on a print job input by an input operation performed by the user. The recording paper sheet to which the toner image is fixed by the image forming unit 14 is output to the outside of the housing 12 by a paper output unit 16.

As illustrated in FIG. 1, the document reader 18 is disposed in an upper section of the image forming apparatus 10. The document reader 18 includes an automatic document feeder (ADF) that automatically feeds document sheets (recording paper sheets on which images are formed). The document reader 18 has a function of reading the images on the document sheets and creating electronic data.

The housing 12 according to the present exemplary embodiment will now be described in detail.

As illustrated in FIG. 2, the housing 12 includes a storage unit 50 and an opening-closing member 60.

The storage unit 50 is a portion of the housing 12 that stores plural boards 100. The storage unit 50 may also be regarded as a region of the housing 12 that stores the boards 100. In the present exemplary embodiment, for example, as illustrated in FIG. 1, the storage unit 50 is provided between the paper output unit 16 and the document reader 18 in the housing 12. The boards 100 are boards for controlling the image forming unit 14.

The storage unit 50 is made of a metal material. More specifically, the storage unit 50 includes a rear wall 12A and a front wall 12B, which are made of metal and define the housing 12. The rear wall 12A is attached to a metal frame (not illustrated) of the housing 12 such that the rear wall 12A is capable of being opened and closed in the left-right direction (width direction). The front wall 12B is fixed to the metal frame.

As illustrated in FIG. 2, the storage unit 50 stores the boards 100 arranged at intervals in a thickness direction of the boards 100. The boards 100 are inserted into the storage unit 50 while the rear wall 12A is opened to expose the storage unit 50. In other words, the boards 100 are successively inserted from a far side of the storage unit 50. The far side of the storage unit 50 refers to a side adjacent to the front wall 12B in the storage unit 50. In other words, in the present exemplary embodiment, an insertion direction in which the boards 100 are inserted into the storage unit 50 is the same as the forward direction of the image forming apparatus 10.

The front wall 12B is a wall defining the storage unit 50 at the far side in the insertion direction of the boards 100. The front wall 12B has an opening 12C covered and uncovered by the opening-closing member 60.

The opening-closing member 60 is a member that is rotatably attached to the front wall 12B to cover and uncover the opening 12C. More specifically, the opening-closing member 60 covers and uncovers the opening 12C in the front wall 12B from the outside of the storage unit 50 (from the front in the present exemplary embodiment). Here, to cover and uncover the opening 12C from the outside of the storage unit 50 means that the opening-closing member 60 opens outward. In addition, in the present exemplary embodiment, while the opening 12C is covered by the opening-closing member 60, an end portion 60A of the opening-closing member 60 is above a rotating shaft 60B. In the present exemplary embodiment, the rotating shaft 60B extends in the apparatus depth direction, that is, in the front-rear direction.

In the present exemplary embodiment, the end portion 60A of the opening-closing member 60 has a through hole 62. A screw member 64 is inserted through the through hole 62 and screwed into a threaded hole 12D formed in the front wall 12B to fix the end portion 60A of the opening-closing member 60 to the front wall 12B.

The rotating mechanism for the opening-closing member 60 may be a commonly known hinge mechanism or other rotating mechanisms.

The opening-closing member 60 is made of a metal material. More specifically, the opening-closing member 60 is a member formed by processing a metal plate.

The boards 100 include a board 100A closest to the far side in the insertion direction. The board 100A is attached to the opening-closing member 60. More specifically, the board 100A is attached to an inner surface 60C of the opening-closing member 60 with screw members 102. The screw members 102 are inserted through attachment holes (not illustrated) formed in flange portions 101 of the board 100A and screwed into the opening-closing member 60.

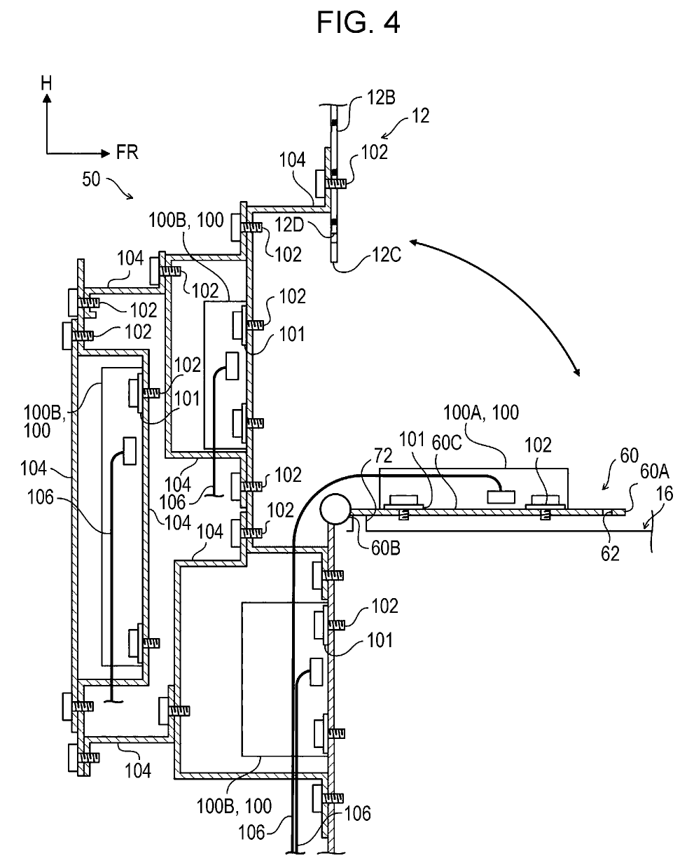

The housing 12 includes a restricting portion 70. The restricting portion 70 is in contact with an outer surface (front surface) of the opening-closing member 60 while the opening-closing member 60 is open. The restricting portion 70 has a function of limiting an opening angle θ of the opening-closing member 60 relative to the front wall 12B within a preset range by coming into contact with the opening-closing member 60. In the present exemplary embodiment, for example, the restricting portion 70 is an upper surface 16A of the paper output unit 16. The upper surface 16A is, for example, a surface that supports front end portions of paper sheets that are output. The present disclosure is not limited to this. For example, as illustrated in FIG. 4, the upper surface 16A may include a projection 72 that serves as a restricting portion, and the apex of the projection 72 may support the opening-closing member 60 to limit the opening angle θ. The shape of the projection 72 is not limited. For example, the projection 72 may include columnar projections arranged at intervals in the apparatus width direction. Alternatively, the projection 72 may be rib-shaped and extend in the apparatus width direction.

The opening angle θ may be set in the range of 90 degrees or more and 180 degrees or less. The opening angle θ is preferably 100 degrees or more and 170 degrees or less.

The boards 100 include boards 100B other than the board 100A. As illustrated in FIG. 2, the boards 100B are attached to the front wall 12B by using brackets 104. More specifically, the boards 100B include flange portions 101 fixed to the brackets 104 with screw members 102. The brackets 104 are fixed to the front wall 12B with screw members 102. In other words, in the present exemplary embodiment, only the board 100A is attached to the opening-closing member 60, and the other boards 100B are attached to the front wall 12B.

The effects of the present exemplary embodiment will now be described.

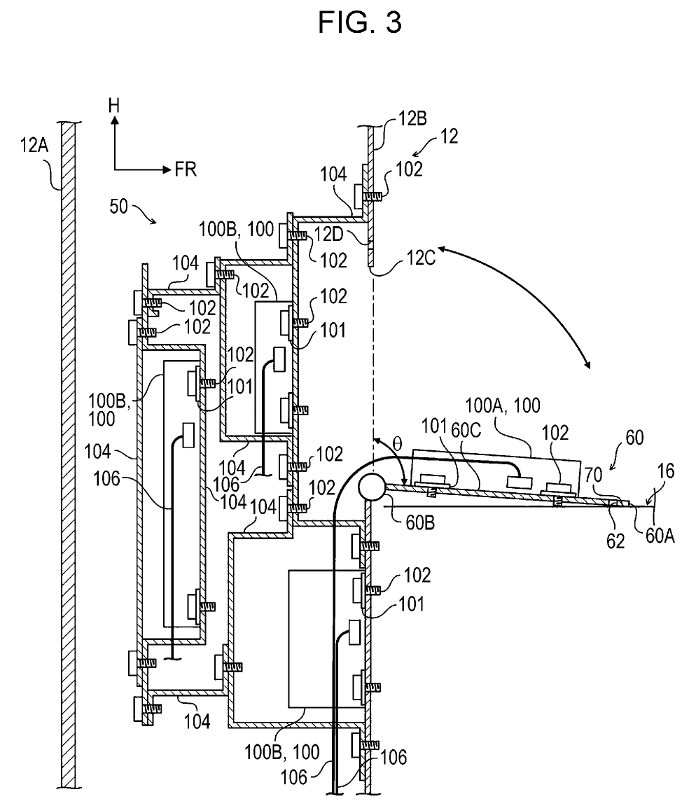

To mount the boards 100 into the housing 12 of the present exemplary embodiment, the boards 100 are successively mounted from the far side of the storage unit 50. More specifically, the board 100A is attached to the opening-closing member 60. Then, a harness 106, which serves as an electrical cable, is connected to the board 100A. Next, the other boards 100B are attached to the front wall 12B by using the brackets 104, and harnesses 106 are connected to the respective boards 100B. Thus, the boards 100 are mounted in the storage unit 50. According to the housing 12 of the present exemplary embodiment, when the board 100A is to undergo maintenance, the board 100A may be accessed by removing the boards 100B and the brackets 104 successively from the near side of the storage unit 50 in the insertion direction. Alternatively, as illustrated in FIG. 3, according to the housing 12 of the present exemplary embodiment, the opening-closing member 60 may be opened to enable access to the board 100A closest to the far side of the storage unit 50 without removing the boards 100B and the brackets 104. After the board 100A has undergone maintenance, the board 100A may be returned to the position closest to the far side of the storage unit 50 by attaching the board 100A to the opening-closing member 60 and connecting the harness 106 to the board 100A.

In the housing 12 of the present exemplary embodiment, the opening-closing member 60 is rotatably attached to the front wall 12B.

In the housing 12 of the present exemplary embodiment, the end portion 60A of the opening-closing member 60 is above the rotating shaft 60B while the opening 12C is covered.

In the housing 12 of the present exemplary embodiment, the restricting portion 70 limits the opening angle θ of the opening-closing member 60 within the preset range.

In the housing 12 of the present exemplary embodiment, the restricting portion 70 limits the opening angle θ within the range of 90 degrees or more and 180 degrees or less.

### Modifications

In the housing 12 of the above-described exemplary embodiment, the upper surface 16A of the paper output unit 16 serves as the restricting portion 70. However, the present disclosure is not limited to this. There is no particular limitation as long as the opening angle θ of the opening-closing member 60 is limited. For example, a projection for limiting the opening angle θ of the opening-closing member 60 may be provided to project upward from a portion of the front wall 12B below the opening 12C. Alternatively, the rotating mechanism for the opening-closing member 60 may include a mechanism for limiting the opening angle θ of the opening-closing member 60.

In addition, in the housing 12 of the above-described exemplary embodiment, the end portion 60A of the opening-closing member 60 is above the rotating shaft 60B while the opening 12C is covered. However, the present disclosure is not limited to this. For example, the end portion 60A of the opening-closing member 60 may be below the rotating shaft 60B while the opening 12C is covered. Alternatively, the end portion 60A of the opening-closing member 60 may be on the left or right side of the rotating shaft 60B while the opening 12C is covered.

### Other Exemplary Embodiments

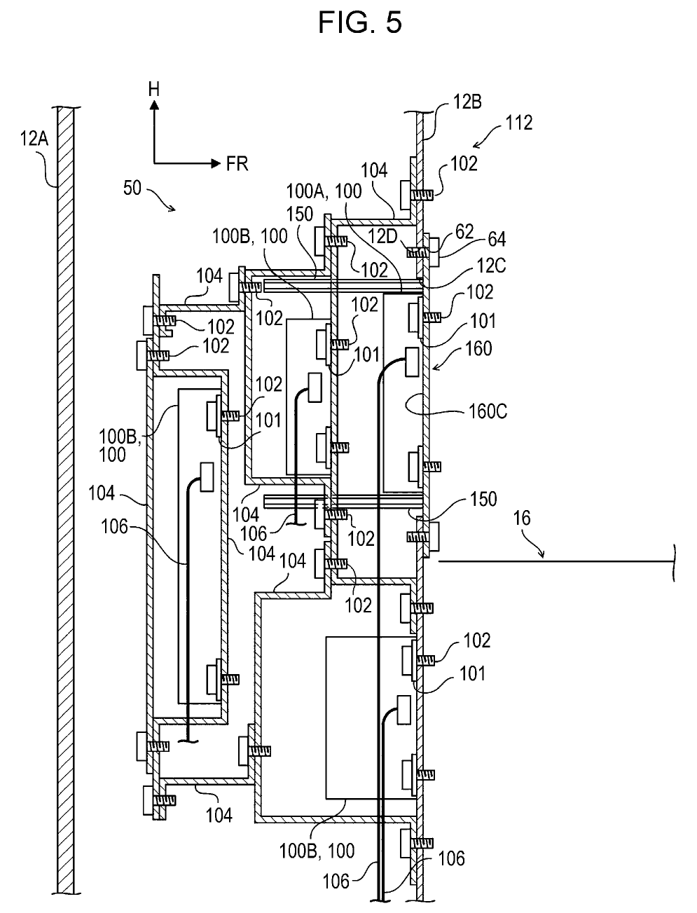

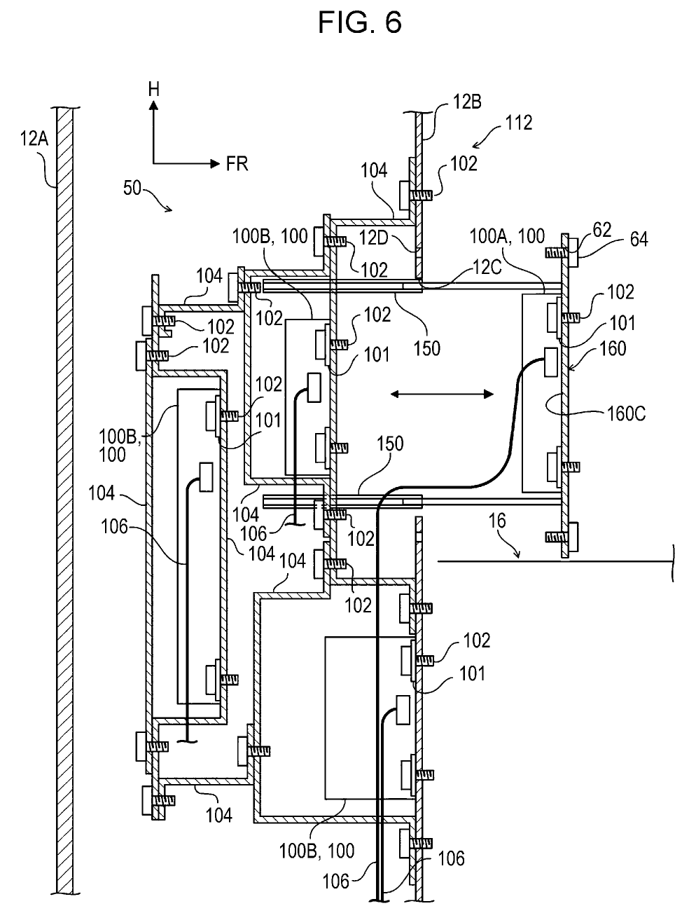

In the housing 12 of the above-described exemplary embodiment, the opening-closing member 60 is rotatably attached to the front wall 12B. However, the present disclosure is not limited to this. As in a housing 112 illustrated in FIGS. 5 and 6, for example, an opening-closing member 160 may be slidably attached to the front wall 12B. More specifically, the opening-closing member 160 is attached to the front wall 12B such that the opening-closing member 160 is slidable toward and away from the opening 12C. The sliding mechanism for the opening-closing member 160 may be a commonly known sliding mechanism or other sliding mechanisms. In the present exemplary embodiment, for example, slide rails 150 are used. In the housing 112, the opening-closing member 160 may be pulled out to enable easy access to the board 100A. After the board 100A has undergone maintenance, the board 100A may be returned to the position closest to the far side of the storage unit 50 by attaching the board 100A to the opening-closing member 160 and connecting the harness 106 to the board 100A.

Although specific exemplary embodiments of the present disclosure have been described in detail, the present disclosure is not limited to these exemplary embodiments. It is obvious to those skilled in the art that various other exemplary embodiments are possible within the scope of the present disclosure. The housing 12 of the present exemplary embodiment may accommodate apparatuses other than the image forming apparatus 10.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

### (((1)))

A housing including:

a storage unit that is made of metal and that stores plural boards arranged at intervals in a thickness direction of the boards; and

an opening-closing member that is made of metal, that is attached to a wall defining the storage unit at a far side in an insertion direction of the boards, that covers and uncovers an opening in the wall from outside of the storage unit, and to which one of the boards that is closest to the far side in the insertion direction is attached.

### (((2)))

The housing according to (((1))), wherein the opening-closing member is rotatably attached to the wall.

### (((3)))

The housing according to (((2))), wherein an end portion of the opening-closing member is above a rotating shaft while the opening is covered.

### (((4)))

The housing according to (((2))) or (((3))), further comprising:

a restricting portion that comes into contact with the opening-closing member to limit an opening angle of the opening-closing member relative to the wall within a preset angle range.

### (((5)))

The housing according to (((4))), wherein the preset angle range is 90 degrees or more and 180 degrees or less.

### (((6)))

The housing according to (((1))), wherein the opening-closing member is attached to the wall such that the opening-closing member is slidable toward and away from the opening.

### (((7)))

An image forming apparatus including:

the housing according to any one of (((1))) to (((6))); and

an image forming unit provided in the housing and controlled by the boards stored in the storage unit to form an image on a paper sheet.

What is claimed is:

1. A housing comprising:
a storage unit that is made of metal and that stores a plurality of boards arranged at intervals in a thickness direction of the boards; and
an opening-closing member that is made of metal, that is attached to a wall defining the storage unit at a far side in an insertion direction of the boards, that covers and uncovers an opening in the wall from outside of the storage unit, and to which one of the boards that is closest to the far side in the insertion direction is attached.

2. The housing according to claim 1, wherein the opening-closing member is rotatably attached to the wall.

3. The housing according to claim 2, wherein an end portion of the opening-closing member is above a rotating shaft while the opening is covered.

4. The housing according to claim 2, further comprising:
a restricting portion that comes into contact with the opening-closing member to limit an opening angle of the opening-closing member relative to the wall within a preset angle range.

5. The housing according to claim 4, wherein the preset angle range is 90 degrees or more and 180 degrees or less.

6. The housing according to claim 1, wherein the opening-closing member is attached to the wall such that the opening-closing member is slidable toward and away from the opening.

7. An image forming apparatus comprising:
the housing according to claim 1; and
an image forming unit provided in the housing and controlled by the boards stored in the storage unit to form an image on a paper sheet.

8. An image forming apparatus comprising:
the housing according to claim 2; and
an image forming unit provided in the housing and controlled by the boards stored in the storage unit to form an image on a paper sheet.

9. An image forming apparatus comprising:
the housing according to claim 3; and
an image forming unit provided in the housing and controlled by the boards stored in the storage unit to form an image on a paper sheet.

10. An image forming apparatus comprising:
the housing according to claim 4; and
an image forming unit provided in the housing and controlled by the boards stored in the storage unit to form an image on a paper sheet.

11. An image forming apparatus comprising:
the housing according to claim 5; and
an image forming unit provided in the housing and controlled by the boards stored in the storage unit to form an image on a paper sheet.

12. An image forming apparatus comprising:
the housing according to claim 6; and
an image forming unit provided in the housing and controlled by the boards stored in the storage unit to form an image on a paper sheet.
